(19) United States
(12) Patent Application Publication
(10) Pub. No.: US 2013/0336305 A1
(43) Pub. Date: Dec. 19, 2013

(54) PERSISTENT LOGICAL DATA TUNNELS

(71) Applicants: Xiangying Yan, Portland, OR (US); Puneet K. Jain, Hillsboro, OR (US); Muthaiah Venkatachalam, Beaverton, OR (US)

(72) Inventors: Xiangying Yan, Portland, OR (US); Puneet K. Jain, Hillsboro, OR (US); Muthaiah Venkatachalam, Beaverton, OR (US)

(21) Appl. No.: 13/883,761

(22) PCT Filed: Aug. 30, 2011
(86) PCT No.: PCT/US11/49640

§ 371 Date: May 6, 2013

Related U.S. Application Data
(60) Provisional application No. 61/410,740, filed on Nov. 5, 2010.

(51) Int. Cl. H04W 40/24

(52) U.S. Cl. CPC H04W 40/24
USPC 370/338

(57) ABSTRACT

Embodiments of the present disclosure describe methods, computer-readable media and system configurations for data delivery among wireless machine-to-machine (“M2M”) and/or machine-type-communication (“MTC”) devices. A method may include receiving, from a plurality of wireless devices (e.g., user equipment or subscriber unit devices), a plurality of uplink data packets, and routing uplink data packets from a subset of the plurality of wireless devices into a logical data tunnel leading to an access gateway. The logical data tunnel may be persistent across sessions of the subset of the plurality of wireless devices. Additionally or alternatively, a method may include incorporating an M2M/MTC payload into data for establishing a connection between a wireless device and a radio access network (“RAN”), so that the wireless device may thereafter enter into an idle mode. Other embodiments may be described and/or claimed.

### FIELD

Embodiments of the present invention relate generally to the field of wireless transmission, and more particularly, to the use of persistent logical data tunnels in a radio access network.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Machine-to-machine (“M2M”) wireless machines or devices (hereafter referred to as “devices”) may communicate primarily or exclusively with other machines or devices, with little or no human intervention. Examples of M2M devices may include wireless weather sensors, assembly line sensors, sensors to track vehicles of a fleet, and so forth. In many cases these devices may log onto a wireless network and communicate with a network server, e.g., on the Internet. In parlance of the 3GPP Long Term Evolution (“LTE”) Release 10 (March 2011) (the “LTE Standard”), M2M may alternatively be referred to as “machine type communications” (“MTC”). M2M devices may also be used with the IEEE 802.16 standard, IEEE Std. 802.16-2009, published May 29, 2009 (“WiMAX”), as well as in Third Generation (“3G”) networks.

The LTE Standard provides for an evolved packet system (“EPS”), which may include an evolved universal terrestrial radio access network (“E-UTRAN”) and an evolved packet core (“EPC”). An EPS bearer may be a logical path through the EPS from a user equipment (“UE”) device to a packet data network gateway (“PGW”), which may in turn lead to a computer network such as the Internet. The E-UTRAN may include an evolved Node B (“eNB”), to which a UE device connects wirelessly. An interface between an eNB and the EPC may be referred to as an S1 interface.

A UE device may transmit and receive two types of data: control data (over what may be referred to as the “control plane”) and user data (over what may be referred to as the “user plane”). Control data transmitted across the S1 interface may be transmitted to a mobile management entity (“MME”) using an S1-MME bearer. User data transmitted across the S1 interface may be transmitted to a gateway (such as a serving gateway, or “SGW”) using an S1-U bearer. An interface between an SGW and a PGW may be referred to as an S5/S8 interface, and control and user data transmitted across this interface may be transmitted using an S5/S8 bearer.

A typical attach procedure used by a UE device to connect to an EPS may include establishment of the following:
1. Radio resource control (“RRC”) connection
2. S1-MME bearer
3. S5/S8 EPS bearer between SGW and PGW
4. radio bearer
5. S1-U bearer

Although an MTC UE device may only need to connect to a wireless network briefly to upload a small amount of data (e.g., to a taxi dispatcher), the MTC UE device may nonetheless be required to establish the above connections and bearers, just like any other UE device, yielding a traffic pattern with a high level of burst. As numbers of MTC UE devices increase, E-UTRANs and/or EPCs may become overloaded. Similar effects may occur in WiMAX and 3G networks.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates an example tunneling scheme, according to an embodiment of the disclosure.

FIG. 2 schematically illustrates an example tunneling scheme used with the LTE protocol, according to an embodiment of the disclosure.

FIG. 3 depicts an example tunneling scheme, similar to that of FIG. 2, from a closer perspective, according to an embodiment of the disclosure.

FIG. 4 schematically illustrates an example of bearers that may be established, according to an embodiment of the disclosure.

FIG. 5 depicts an example of incorporating “machine type communications” (“MTC”) data with data used to establish a connection to an E-UTRAN, according to an embodiment of the disclosure.

FIG. 6 depicts example data for establishing a connection between a user equipment (“UE”) device and an evolved Node B (“eNB”), according to an embodiment of the disclosure.

FIG. 7 depicts an example method, according to an embodiment of the disclosure.

FIG. 8 depicts an example method, according to an embodiment of the disclosure.

FIG. 9 depicts an example method, according to an embodiment of the disclosure.

FIG. 10 depicts an example system, according to an embodiment of the disclosure.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

In some embodiments, a computer-implemented method may include receiving, by a radio access network node (“RAN node”), from a plurality of wireless devices, a plurality of uplink data packets. The method may further include routing, by the RAN node, uplink data packets from a subset of the plurality of wireless devices into a logical data tunnel leading to an access gateway. In some embodiments, the logical data tunnel may be persistent across sessions of the subset of the plurality of wireless devices.

In some embodiments, the RAN node may be an evolved Node B (“eNB”), the plurality of wireless devices is a plurality of user equipment (“UE”) devices and the access gateway is a serving gateway (“SGW”). In some embodiments, the subset of the plurality of UE may be a first subset and the logical data tunnel may be a first logical data tunnel. In some embodiments, the method may further include routing, by the eNB, uplink data packets from a second subset of the plurality of UE into a second logical data tunnel leading to the gateway. In some embodiments, the second logical data tunnel may be persistent across UE sessions of the second subset of the plurality of UE devices.

In some embodiments, UE devices of the first subset may be machine-type communication (“MTC”) devices. In some embodiments, the method may further include receiving, by an eNB, from a gateway through a logical data tunnel, a plurality of downlink data packets, and routing, by the eNB, a first downlink data packet of the plurality of downlink data packets to a selected UE device. In some embodiments, the method may further include inspecting, by the eNB, the first downlink data packet to ascertain an address of the selected UE device.

In some embodiments, the method may further include creating, by the eNB, a mapping between a destination network address of the first downlink data packet to an identifier of a bearer, and routing, by the eNB, downlink data packets addressed to the selected UE device on the bearer based on the mapping. I some embodiments, the network address may be an internet protocol (“IP”) address and the identifier of the bearer may be a radio access bearer identifier (“RABID”).

In some embodiments, the method may further include receiving, by the eNB, from a first UE device of the plurality of UE devices, data for establishing a connection with the first UE device, wherein the data includes an MTC payload, and forwarding, by the eNB, the MTC payload through the logical data tunnel.

In some embodiments, a computer-implemented method may include receiving, by an eNB, from a UE device, data for establishing a radio resource control (“RRC”) connection between the UE device and the eNB, wherein the data includes a MTC payload, extracting, by the eNB, the MTC payload and a destination from the data for establishing the RRC connection, and forwarding, by the processor, the MTC payload through a logical data tunnel towards the destination.

In some embodiments, a computer system may be provided and may include one or more processors and a control module. The control module may be configured to be operated by a processor of the one or more processors to facilitate establishment of a logical data tunnel between a RAN node and one or more access gateways, wherein uplink data packets from a subset of a plurality of wireless devices are multiplexed into the logical data tunnel. In some embodiments, the logical data tunnel may be persistent across a plurality of wireless device sessions.

In some embodiments, a UE device may include a wireless network adaptor and a control module. The control module may be configured to transmit, through the wireless network adaptor, to a mobility management entity (“MME”) of an evolved universal terrestrial radio access network (“E-UTRAN”), via a non-access stratum (“NAS”) signal, MTC data about the UE device that facilitates mapping of the UE device to a logical data tunnel between an eNB and one or more SGW. In some embodiments, the logical data tunnel may be persistent across UE sessions of a plurality of UE devices and is shared by an MTC subset of the plurality of UE devices.

In various embodiments, methods and/or non-transitory computer-readable media having a number of the above described operations may be practiced and/or executed. In various embodiments, apparatus and/or systems may be configured to practice such methods.

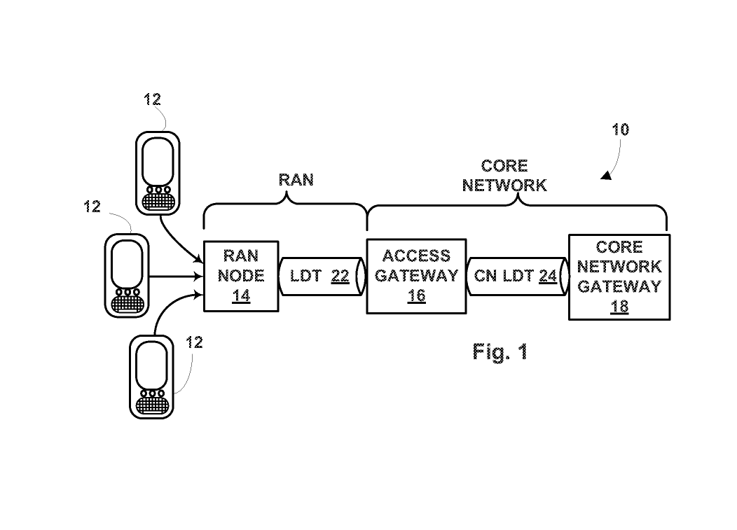

FIG. 1 schematically illustrates an example wireless network 10 that includes a radio access network (“RAN”) and a core network (“CN”). Network 10 may be a 3G network, an LTE (“4G”) network, a WiMAX network, and so forth. A wireless device 12 (e.g., a UE device in 3G and 4G or a subscriber unit, or “SU,” in WiMAX) may be configured to connect to the RAN of network 10 through a RAN node 14. Depending on the type of network, the RAN node 14 may be an eNB (3G and 4G), a base station (WiMAX), a wireless access point, and so forth. The RAN node 14 may route data packet traffic to/from the wireless device 12 to an access gateway 16, which in turn may route data packet traffic to/from a CN gateway 18. CN gateway 18 may lead to various other networks, such as the Internet.

If the wireless device 12 is a Machine-to-machine (“M2M”) or MTC device, then the repeated connection and disconnection that may be required for it, and similar M2M/MTC wireless devices, to upload small amounts of data may result in considerable overhead. Accordingly, a logical data tunnel 22 (“LDT” in the drawings) may be established and maintained between the RAN node 14 and the access gateway 16. The logical data tunnel 22 may be persistent across sessions of a plurality of M2M/MTC wireless devices 12, so that separate connection/attachment is not necessary. In some embodiments, the logical data tunnel 22 may be implemented using the General Packet Radio Service Tunneling Protocol (“GTP”). A CN logical data tunnel 24 also may be established between access gateway 16 and CN gateway 18. Similar to the logical data tunnel 22, the CN logical data tunnel 24 be persistent across sessions of a plurality of M2M/MTC wireless devices.

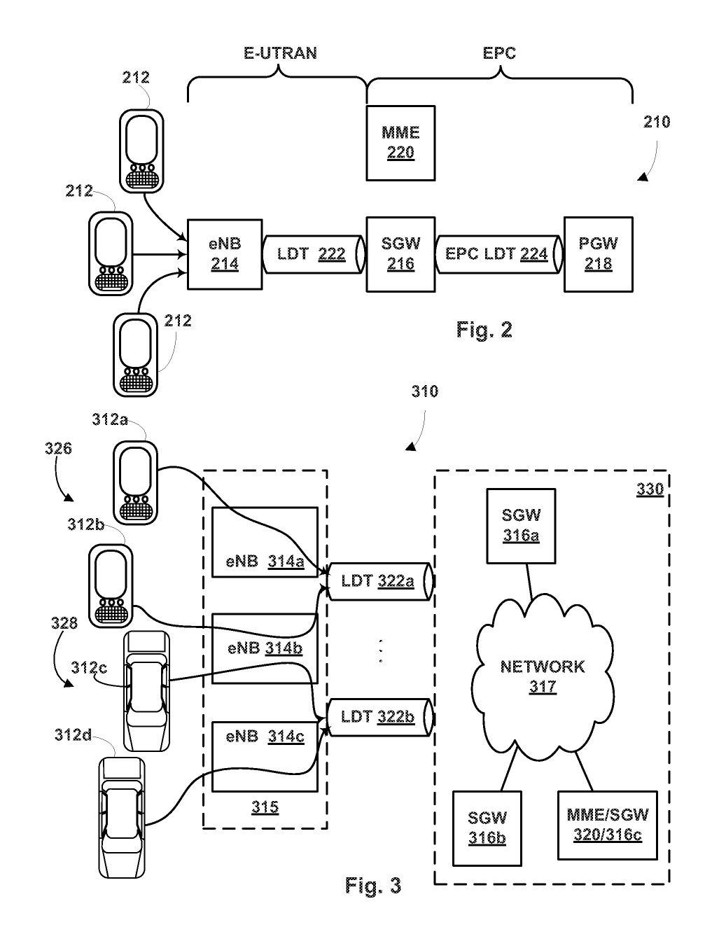

FIG. 2 schematically illustrates one type of a network, in the form of an evolved packet system (“EPS”) 210 as provided by the LTE standard, in accordance with various embodiments. EPS 210 includes an E-UTRAN and an evolved packet core (“EPC”). One or more UE device(s) 212 may be configured to connect to the E-UTRAN of EPS 210 through an eNB 214. The eNB 214 may route data packet traffic to/from the UE device(s) 212 to an SGW 216, which in turn may route data packet traffic to/from a packet data network gateway (“PGW”) 218. Additionally, an MME 220 may be provided to perform various control functions for the EPS 210.

Rather than establish/reestablish separate connections to each UE device 212 that is an MTC UE device, the eNB 214 may be configured to route (e.g., multiplex) uplink data packets from a plurality of MTC UE devices into the logical data tunnel 222. Thus, the logical data tunnel 222 may be a persistent S1-U bearer that may be shared among a particular subset of MTC UE devices. Similarly, the EPC logical data tunnel 224 may be a persistent S5/S8 bearer that may be shared among a particular subset of MTC UE devices. Thus, it may not be necessary to establish a separate S1-U or S5/S8 bearer each time an MTC UE device connects.

FIG. 3 depicts a portion of an EPS 310 similar to the EPS 210 of FIG. 2, in accordance with some embodiments. In FIG. 3 there is a plurality of eNBs 314, indicated at 315, that may communicate with a plurality of SGWs 316, connected by a network 317 and indicated generally at 330. As an MTC UE device moves about it may connect to and be shuffled between multiple eNBs 314 of the plurality 315. For example, one eNB, e.g., eNB 314a may connect to one SGW, e.g., SGW 316a, and another eNB, e.g., 314b, may connect to another SGW, e.g., 316b, so that as an MTC UE device 312 travels its traffic is routed through any number of eNB/SGW combinations.

If, each time an MTC UE device 312 transitioned from RRC_IDLE to RRC_CONNECTED, it were required to reestablish all the bearers and connections described in the background, the E-UTRAN and/or EPC may be burdened. Accordingly, persistent logical data tunnels 322 may be established between the plurality 315 of eNBs 314 and the plurality 330 of SGWs 316, and each logical data tunnel 322 may be shared by particular subsets of MTC UE devices.

MTC UE devices 312 may be grouped into subsets for various reasons. For example, MTC UE devices 312 with a common purpose may communicate with a common MTC server, and therefore may be grouped into a subset so that uplink transmissions from these devices may all be multiplexed into a single logical data tunnel. Additionally or alternatively, a plurality of UE devices may be grouped into a subset based on their having similar quality of service (“QoS”) requirements.

A first subset 326 of MTC UE devices 312 shown in FIG. 3 may include a first MTC UE device 312a and a second MTC UE device 312b of a particular type, such as smart phones that are deployed for a particular purpose. For example, members of a sales team may carry smart phones designed to automatically transmit small amounts of MTC data back to a home server at periodic intervals. A second subset 328 of MTC UE devices 312 shown in FIG. 3 may include a first MTC meter 312c and a second MTC meter 312d used in taxi cabs. These meters may be configured to transmit MTC data to a dispatcher for various purposes, such as tracking a driver's route throughout his or her shift.

First MTC UE device 312a of first subset 326 is connected to a first eNB 314a. Second MTC UE device 312b of first subset 326 connects to a different eNB, e.g., eNB 314b. Yet, both eNBs are configured to route uplink data packets received from first subset 326 through a first logical data tunnel 322a. Indeed, every eNB 314 in the plurality 315 may be configured to multiplex uplink data packets received from first subset 326 through first logical data tunnel 322a. Thus, wherever an MTC UE device (e.g., 312a, 312b) from first subset 326 travels, its uplink data traffic may be routed through the same logical data tunnel 322a.

First MTC meter 312c of second subset 328 is connected to the second eNB 314b. Second MTC meter 312d of second subset 328 connects to a different eNB, e.g., eNB 314c. Yet once again, both eNBs are configured to route uplink data packets received from second subset 328 through a second logical data tunnel 322b. Indeed, every eNB 314 in the plurality 315 may be configured to multiplex uplink data packets from MTC meters in second subset 328 through the second logical data tunnel 322b. Thus, wherever an MTC meter (e.g., 312c, 312d) from second subset 328 travels, its uplink data traffic may be routed through the same logical data tunnel 322b.

While uplink data may be multiplexed from UE devices of a subset through a single logical data tunnel, downlink data may be de-multiplexed from a logical channel to individual UE devices. An eNB may be configured to receive, from an SGW through a logical data tunnel, a plurality of downlink data packets, and route individual downlink data packets to selected UE devices. This downlink routing may be implemented in various ways. In some embodiments, an eNB may be configured to inspect a downlink data packet to ascertain an address of the destination UE device. Packet inspection may require additional processing and so may be more suitable in an eNB with a relatively high level of processing power.

In other embodiments, an eNB may be configured to create a mapping between a destination network address of a first downlink data packet and an identifier of a bearer. The eNB may then route downlink data packets addressed to the selected UE device on the bearer based on the mapping. In some embodiments, the network address may be an internet protocol (“IP”) address and the identifier of the bearer may be a radio access bearer identifier (“RABID”). This method may utilize less overhead than packet inspection as the eNB would not need to maintain tunnel endpoint identifier (“TEID”) to RABID mappings.

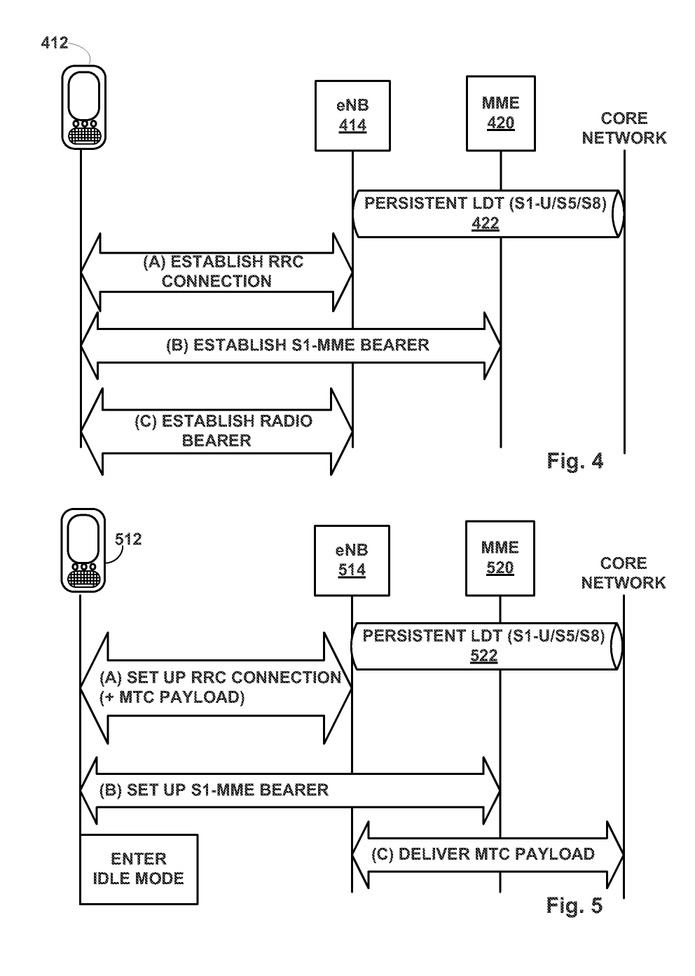

FIG. 4 depicts an attachment procedure in accordance with various embodiments implementing the LTE standard. A persistent logical data tunnel 422 is depicted to represent both a logical data tunnel (e.g., 222, 322) between eNBs and SGWs and a persistent MTC S5/S8 tunnel (e.g., 224) between an SGW (e.g., 216, 316) and a PGW (e.g., 218). With this tunnel “always on,” an attachment procedure normally required for connection of an MTC UE device 412 (e.g., when it returns from RRC_IDLE to RRC_CONNECTED) may be expedited. Rather than establishing the five bearers and connections as described in the background, UE device 412 may perform an expedited attachment procedure by establishing: (A) an RRC connection with an eNB 414; (B) an S1-MME bearer with MME 420; and (C) a radio bearer between the UE device 412 and the eNB 414. The MTC UE device 412 may not need to establish an S1-U bearer or S5/S8 bearer in the expedited attachment procedure because those bearers are already maintained in the persistent logical data tunnel 422.

The aforementioned methods may be implemented in UE devices and/or eNBs. However, other nodes of an EPS and/or EPC may be modified in order to implement disclosed methods. For example, an MME may be configured to identify, e.g., via non-access stratum (“NAS”) signaling, a new attach request as being from an MTC UE device, as opposed to a traditional UE device (e.g., cellular telephone). In those situations, the MME may map the MTC UE device to a particular shared logical data tunnel based on the MTC data about the MTC UE device. In this way the MME is compatible with the MTC UE device 412 described above in that it is able to skip some attachment procedures, such as establishing a S1-U or S5/S8 bearer.

Referring back to FIG. 2, the MME 220 may be configured to facilitate establishment of the logical data tunnel 222 between the eNB 214 and the SGW 216, so that uplink data packets from a subset of a plurality of UE devices are multiplexed into the logical data tunnel 222. The MME 220 may receive, from the UE device 212 through a NAS signal (not shown), MTC data about the UE device 212 that facilitates mapping of the UE device 212 to logical data tunnel 222. Data about the UE device 212 may include but is not limited to an MTC indication, an MTC subcategory and/or an MTC service in which the UE device 212 participates.

In some embodiments, only some nodes of the EPS may be MTC-specific. In such a situation, an eNB may be configured to route attach requests from MTC UE devices to MTC-specific nodes and gateways, rather than using load balancing to choose an MME or SGW.

In additional to establishing and maintaining persistent logical data tunnels, other features may be implemented to simplify and/or reduce MTC congestion and overloading. For example, an MTC UE device such as a sensor may only need to transmit a small amount of data at a time, and may not need a connection as robust as that which would normally be established with, e.g., a smart phone. Accordingly, an MTC UE device may be configured to incorporate an MTC payload into data for establishing a connection with an E-UTRAN.

An example of this is shown in FIG. 5, which depicts an attachment procedure similar to that of FIG. 4 in accordance with some embodiments. A persistent logical data tunnel 522 is established so that an S1-U bearer and an S5/S8 bearer are always on. An MTC UE device 512 implements a similar attachment procedure as that shown in FIG. 4. However, in the course of setting up an RRC connection, the UE device includes, with data for establishing the connection to the E-UTRAN (e.g., an RRCConnectionComplete communication), an MTC payload. Additionally, rather than establish a radio bearer, the MTC UE device 512 enters into idle mode (e.g., RRC_IDLE), as it no longer needs a connection to the network. In this manner an MTC UE device may upload data and immediately disconnect, before establishing a more robust traditional connection that would require additional resources.

NAS signaling may be transparent to an eNB. That means an eNB 514 may not have received MTC data about the UE device that was previously sent to the MME as described above. Thus, when the MTC UE device 512 sends to the eNB 514 data for establishing a connection with an E-UTRAN (e.g., RRCConnectionComplete) with an MTC payload, the eNB 514 may need to be told where to route the MTC payload. Accordingly, in addition to the MTC payload, the MTC UE device 512 may also incorporate, into the data for establishing a connection with an E-UTRAN (e.g., RRCConnectionComplete), an MTC UE identity, access class information, an MTC subcategory and/or MTC service information. The eNB 514 and/or other nodes of an EPS may be configured to extract this data and utilize it to ensure that the piggybacked MTC data payload is forwarded to an appropriate destination. In some embodiments, the eNB 514 may forward the payload over an EPC logical data tunnel (e.g., EPC logical data tunnel 224).

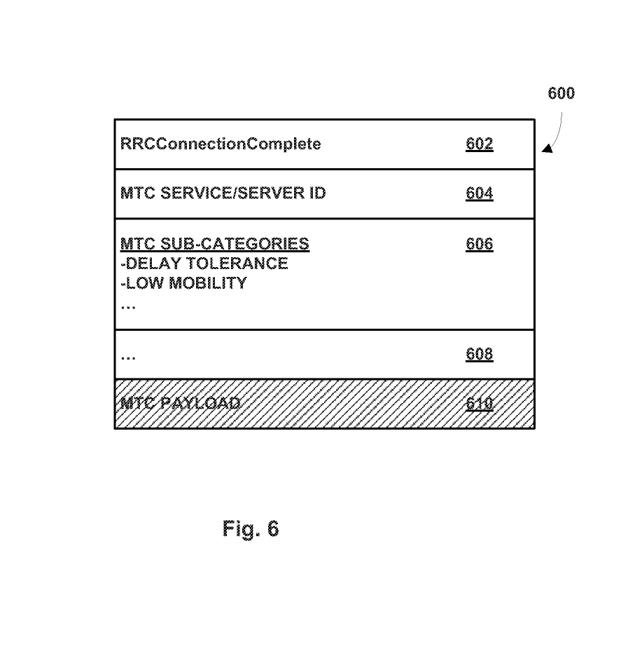

An example communication 600 is shown in FIG. 6 in accordance with some embodiments. The communication 600 includes a header 602 that identifies it as an RRCConnectionComplete communication. It also includes an MTC service or server ID 604, which identifies a service or server to which the MTC UE device belongs or communicates with (and which may therefore identify a destination of the MTC payload). MTC sub-categories 606 indicate various parameters of the MTC service or server, such as its delay tolerance or mobility tolerance. Other data, which is not relevant to present discussion, may be included at 608. Finally, the communication 600 may include an MTC payload 610, which is shaded to indicate that it may be encrypted (e.g., by a UE device). To determine the appropriate destination for the MTC payload, EPS nodes such as eNBs may utilize methods such as packet inspection and IP-address-RABID mapping to ascertain the MTC service/server and route MTC payloads accordingly.

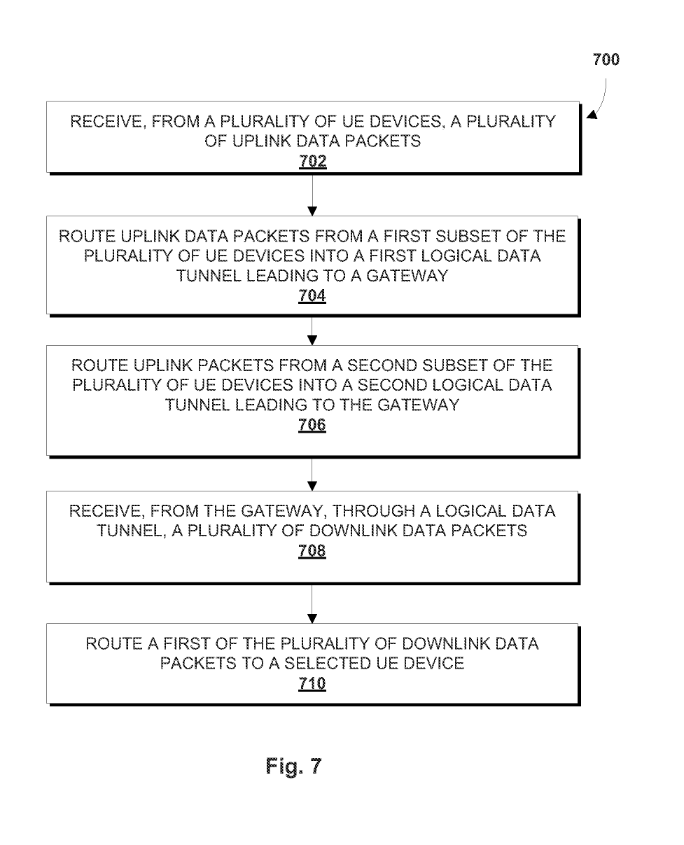

Example methods that may be implemented at various nodes of an EPS are shown in FIGS. 7-9 in accordance with some embodiments. Although shown in a particular order, this is not meant to be limiting, as these actions may be performed in various orders.

A method 700 that may be implemented at an eNB to route packets through persistent logical data tunnels is shown in FIG. 7. Uplink data packets from UE devices to a CN are processed at 702-706. At 702, a plurality of uplink data packets may be received from a plurality of UE devices. At 704, uplink data packets from a first subset (e.g., 326) of the plurality of UE devices may be routed into a first logical data tunnel (e.g., 322a) leading to a gateway. At 706, uplink data packets from a second subset (e.g., 328) of the plurality of UE devices may be routed into a second logical data tunnel (e.g., 322b) leading to the same or a different gateway. Although only two are described here, any number of logical tunnels may be created and used, depending on the number of subsets of UE devices.

Downlink data packets from a CN to UE devices are processed at 708-710. At 708, a plurality of downlink data packets may be received by an eNB (e.g., 214 314, 414, 514) from a gateway (e.g., 216, 316) through a logical data tunnel (e.g., 222, 322, 422, 522). At 710, a first of the plurality of downlink data packets may be forwarded to a selected UE device to which it is addressed. As noted above, an eNB may forward downlink data packets using deep packet inspection or using IP-address-to-RABID mapping.

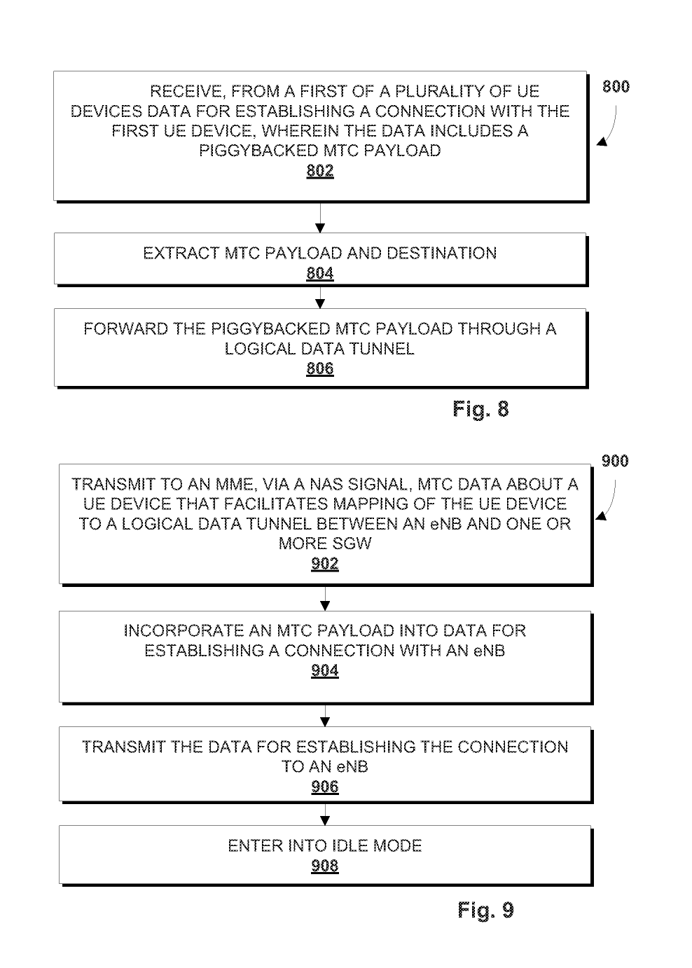

FIG. 8 depicts an example method 800 that may be implemented on an eNB (e.g., 214, 314, 414, 514). At 802, data for establishing a connection with a first UE device (e.g., 212, 312, 412, 512) may be received by an eNB (e.g., 214, 314, 414, 514). The UE device may be a simple sensor or meter, and therefore may only need to transmit a small amount of MTC data to the network and disconnect. Accordingly, the data for establishing the connection may include a piggybacked MTC payload. At 804, the payload and its destination may be extracted. For example, the eNB (e.g., 214, 314, 414, 514) may perform packet inspection or IP-address-to-RABID mapping to determine a destination of the MTC payload. At 806 the MTC payload may be forwarded through a logical data tunnel (e.g., 222, 322, 422, 522).

FIG. 9 depicts an example method 900 that may be implemented by an MTC UE device (e.g., 212, 312, 412, 512) in an EPS under the LTE standard. At 902, MTC data about the MTC UE device that facilitates mapping of the MTC UE device to a logical data tunnel (e.g., 222, 322, 422, 522) between an eNB (e.g., 214, 314, 414, 514) and an SGW (e.g., 216, 316a, 316b, 316c), may be transmitted to an MME (e.g., 220, 320, 420, 520). This data may be transmitted using an NAS signal.

At 904, the UE device (e.g., 212, 312, 412, 512) may incorporate an MTC payload into data for establishing a connection between the UE device and an E-UTRAN, such as an RRCConnectionComplete transmission. At 906 this data may be transmitted to an eNB (e.g., 214, 314, 414, 514). At 908, because the UE device has already transmitted its payload and no longer needs to use the network, the UE device may enter into idle mode (e.g., RRC_IDLE).

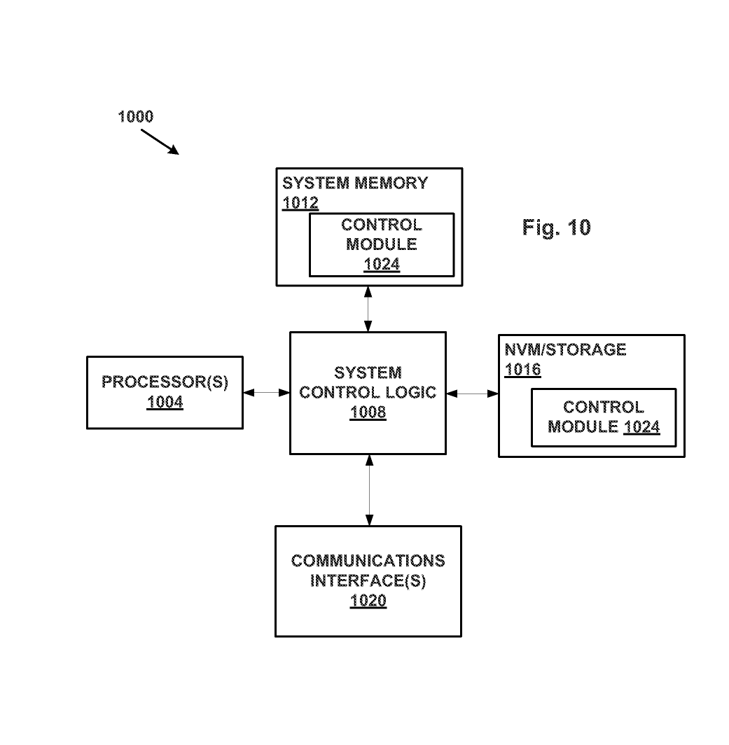

The techniques and apparatuses described herein may be implemented into a system using suitable hardware and/or software to configure as desired. FIG. 10 illustrates, for one embodiment, an example system 1000 comprising one or more processor(s) 1004, system control logic 1008 coupled to at least one of the processor(s) 1004, system memory 1012 coupled to system control logic 1008, non-volatile memory (NVM)/storage 1016 coupled to system control logic 1008, and one or more communications interface(s) 1020 coupled to system control logic 1008.

System control logic 1008 for one embodiment may include any suitable interface controllers to provide for any suitable interface to at least one of the processor(s) 1004 and/or to any suitable device or component in communication with system control logic 1008.

System control logic 1008 for one embodiment may include one or more memory controller(s) to provide an interface to system memory 1012. System memory 1012 may be used to load and store data and/or instructions, for example, for system 1000. System memory 1012 for one embodiment may include any suitable volatile memory, such as suitable dynamic random access memory (“DRAM”), for example.

System control logic 1008 for one embodiment may include one or more input/output (I/O) controller(s) to provide an interface to NVM/storage 1016 and communications interface(s) 1020.

NVM/storage 1016 may be used to store data and/or instructions, for example. NVM/storage 1016 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s) for example.

The NVM/storage 1016 may include a storage resource physically part of a device on which the system 1000 is installed or it may be accessible by, but not necessarily a part of, the device. For example, the NVM/storage 1016 may be accessed over a network via the communications interface(s) 1020.

System memory 1012 and NVM/storage 1016 may include, in particular, temporal and persistent copies of control module 1024, respectively. The control module 1024 may include instructions that when executed by at least one of the processor(s) 1004 result in the system 1000 performing logical data tunnel routing operations as described above with respect to, for example, one or more nodes of the network 10 of FIG. 1, the EPS 210 of FIG. 2 or the EPS 310 of FIG. 3. In some embodiments, the control module 1024 may additionally/alternatively be located in the system control logic 1008.

Communications interface(s) 1020 may provide an interface for system 1000 to communicate over one or more network(s) and/or with any other suitable device. Communications interface(s) 1020 may include any suitable hardware and/or firmware. Communications interface(s) 1020 for one embodiment may include, for example, a wireless network adapter. The communications interface(s) 1020 may use one or more antenna(s).

For one embodiment, at least one of the processor(s) 1004 may be packaged together with logic for one or more controller(s) of system control logic 1008. For one embodiment, at least one of the processor(s) 1004 may be packaged together with logic for one or more controllers of system control logic 1008 to form a System in Package (“SiP”). For one embodiment, at least one of the processor(s) 1004 may be integrated on the same die with logic for one or more controller(s) of system control logic 1008. For one embodiment, at least one of the processor(s) 1004 may be integrated on the same die with logic for one or more controller(s) of system control logic 1008 to form a System on Chip (“SoC”).

The system 1000 may be a desktop or laptop computer, a mobile telephone, a smart phone, or any other device adapted to receive a wireless communication signal. In various embodiments, system 1000 may have more or less components, and/or different architectures.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. A computer-implemented method, comprising:
receiving, by a radio access network node (“RAN node”), from a plurality of wireless devices, a plurality of uplink data packets; and
routing, by the RAN node, uplink data packets from a subset of the plurality of wireless devices into a logical data tunnel leading to an access gateway;
wherein the logical data tunnel is persistent across sessions of the subset of the plurality of wireless devices.

2. The computer-implemented method of claim 1, wherein the RAN node is an evolved Node B (“eNB”), the plurality of wireless devices is a plurality of user equipment (“UE”) devices and the access gateway is a serving gateway (“SGW”).

3. The computer-implemented method of claim 2, wherein the subset of the plurality of UE is a first subset, the logical data tunnel is a first logical data tunnel, the method further comprising:
routing, by the eNB, uplink data packets from a second subset of the plurality of UE into a second logical data tunnel leading to the gateway;
wherein the second logical data tunnel is persistent across UE sessions of the second subset of the plurality of UE devices.

4. The computer-implemented method of claim 2, wherein UE devices of the first subset are machine-type communication (“MTC”) devices.

5. The computer-implemented method of claim 2, further comprising:
receiving, by the eNB, from the gateway through the logical data tunnel, a plurality of downlink data packets; and
routing, by the eNB, a first downlink data packet of the plurality of downlink data packets to a selected UE device.

6. The computer-implemented method of claim 5, further comprising inspecting, by the eNB, the first downlink data packet to ascertain an address of the selected UE device.

7. The computer-implemented method of claim 5, further comprising:
creating, by the eNB, a mapping between a destination network address of the first downlink data packet to an identifier of a bearer; and
routing, by the eNB, downlink data packets addressed to the selected UE device on the bearer based on the mapping.

8. The computer-implemented method of claim 7, wherein the network address is an internet protocol (“IP”) address and the identifier of the bearer is a radio access bearer identifier (“RABID”).

9. The computer-implemented method of claim 2, further comprising:
receiving, by the eNB, from a first UE device of the plurality of UE devices, data for establishing a connection with the first UE device, wherein the data includes a machine-type communication (“MTC”) payload; and
forwarding, by the eNB, the MTC payload through the logical data tunnel.

10. A computer-implemented method, comprising:
receiving, by an evolved Node B (“eNB”), from a user equipment (“UE”) device, data for establishing a radio resource control (“RRC”) connection between the UE device and the eNB, wherein the data includes a machine-type communication (“MTC”) payload;
extracting, by the eNB, the MTC payload and a destination from the data for establishing the RRC connection; and
forwarding, by the processor, the MTC payload through a logical data tunnel towards the destination.

11. The computer-implemented method of claim 10, further comprising:
receiving, by the processor, from a plurality of UE devices, a plurality of uplink data packets; and
routing, by the processor, uplink data packets from an MTC subset of the plurality of UE devices into the logical data tunnel;
wherein the logical data tunnel is persistent across UE sessions of the MTC subset of the plurality of UE devices.

12. The computer-implemented method of claim 11, wherein the MTC subset is a first MTC subset, the method further comprising:
routing, by the processor, uplink data packets from a second MTC subset of the plurality of UE into a second logical data tunnel leading to the gateway;
wherein the second logical data tunnel is persistent across UE sessions of the second subset of the plurality of UE devices.

13. The computer-implemented method of claim 10, further comprising:
receiving, by the processor from the gateway through the logical data tunnel, a plurality of downlink data packets; and
routing, by the processor, a first downlink data packet of the plurality of downlink data packets to a selected UE device.

14. The computer-implemented method of claim 13, further comprising:
inspecting the first downlink data packet to ascertain an address of the selected UE device; or
creating a mapping between a destination network address of the first downlink data packet to an identifier of a bearer.

15. A computer system, comprising:
one or more processors;
a control module configured to be operated by a processor of the one or more processors to:
facilitate establishment of a logical data tunnel between a radio access network node (“RAN node”) and one or more access gateways, wherein uplink data packets from a subset of a plurality of wireless devices are multiplexed into the logical data tunnel;
wherein the logical data tunnel is persistent across a plurality of wireless device sessions.

16. The computer system of claim 15, wherein wireless devices of the subset are machine-type communication (“MTC”) UE devices.

17. The computer system of claim 15, wherein the plurality of wireless devices are UE devices, the RAN node is an eNB and the one or more access gateways are serving gateways (SGW), and the control module is further configured to receive, from a first UE device of the plurality of UE devices through a non-access stratum (“NAS”) signal, machine-type communication (“MTC”) data about the first UE device that facilitates mapping of the first UE device to the logical data tunnel between the one or more SGWs and the eNB.

18. The computer system of claim 17, wherein the MTC data about the first UE device that facilitates mapping of the first UE device to the logical data tunnel includes an MTC indication, an MTC subcategory or an MTC service.

19. A user equipment (“UE”) device comprising:
a wireless network adaptor; and
a control module configured to transmit, through the wireless network adaptor, to a mobility management entity (“MME”) of an evolved universal terrestrial radio access network (“E-UTRAN”), via a non-access stratum (“NAS”) signal, machine type communication (“MTC”) data about the UE device that facilitates mapping of the UE device to a logical data tunnel between an evolved Node B (“eNB”) and one or more serving gateways (“SGW”);
wherein the logical data tunnel is persistent across UE sessions of a plurality of UE devices and is shared by an MTC subset of the plurality of UE devices.

20. The UE device of claim 19, wherein the control module is further configured to:
incorporate an MTC payload into data for establishing a connection with the E-UTRAN;
transmit, through the wireless network adaptor, the data for establishing the connection to the eNB; and
after transmitting the data, enter into an idle mode.

21. The UE device of claim 19, wherein the data for establishing the connection is an RRCConnectionComplete communication.

22. The UE device of claim 19, wherein the data for establishing the connection includes an MTC UE identity, access class information, an MTC subcategory or MTC service information.

23. The UE device of claim 19, wherein the control module is further configured to encrypt the MTC payload prior to incorporating it into the data for establishing the connection with the E-UTRAN.
